(19) United States
(12) Patent Application Publication
(10) Pub. No.: US 2008/0127631 A1
(43) Pub. Date: Jun. 5, 2008

(54) METHOD FOR REMOVAL OF MERCURY FROM THE EMISSIONS STREAM OF A POWER PLANT AND AN APPARATUS FOR ACHIEVING THE SAME

(75) Inventors: Deborah Ann Haitko, Schenectady, NY (US); Vitali Lissianski, San Juan Capo, CA (US); Alison Liana Palmatier, Porter Corners, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company, Schenectady, NY (US)

(21) Appl. No.: 11/565,097

(22) Filed: Nov. 30, 2006

(51) Int. Cl. F01N 3/20; B01J 27/08; B01J 27/122; B01J 27/128

(52) U.S. Cl. 60/273; 502/224; 502/229; 502/231; 502/87; 502/226; 502/178; 502/174; 502/225

(57) ABSTRACT

Disclosed herein is a catalyst composition comprising a halide of a Group Ib element and an inert powder. Disclosed herein too is a composition comprising a reaction product of a halide of a Group Ib element, an inert powder and mercury. Disclosed herein too is a method comprising injecting a catalyst composition comprising a halide of a Group Ib element and an inert powder into an emissions stream of a thermoelectric power plant; converting an elemental form of mercury present in the emissions stream into an oxidized form, an amalgamated form and/or a particulate bound form of mercury; and collecting the oxidized form, the amalgamated form and/or the particulate bound form of mercury prior to the entry of the emissions stream into the atmosphere.

### BACKGROUND

This disclosure relates to a method for removal of mercury from the emissions stream of a power plant. It also relates to an apparatus for accomplishing the removal of the mercury.

Mercury is a regulated hazardous metal that is present in coal. The flue gas in coal-powered plants generally comprises a large percentage of mercury. Mercury exists in two forms namely, an oxidized form and an elemental form. Of the two forms, elemental mercury is generally more difficult to remove from emissions generated in from power generation facilities. Release of mercury from United States based coal burning facilities amounts to 48 metric tons per year. Regulations have been enacted to control the mercury emissions from coal burning facilities such as coal-fired power plants.

It is therefore desirable to have a method to extract mercury from emissions prior to its entry into the atmosphere.

### SUMMARY

Disclosed herein is a catalyst composition comprising a halide of a Group Ib element and an inert powder.

Disclosed herein too is a composition comprising a reaction product of a halide of a Group Ib element, an inert powder and mercury.

Disclosed herein too is a method comprising injecting a catalyst composition comprising a halide of a Group Ib element and an inert powder into an emissions stream of a thermoelectric power plant; converting an elemental form of mercury present in the emissions stream into an oxidized form, an amalgamated form and/or a particulate bound form of mercury; and collecting the oxidized form, the amalgamated form and/or the particulate bound form of mercury prior to the entry of the emissions stream into the atmosphere.

Disclosed herein too is a method comprising injecting a first portion of a first catalyst composition comprising a halide of a Group Ib element and an inert powder into an emissions stream of a thermoelectric power plant; injecting a second portion of a second catalyst composition comprising a halide of a Group Ib element and an inert powder into the emissions stream of the thermoelectric power plant; injecting a third portion of a third catalyst composition comprising a halide of a Group Ib element and an inert powder into the emissions stream of the thermoelectric power plant; converting an elemental form of mercury present in the emissions stream into an oxidized form, an amalgamated form and/or a particulate bound form of mercury; and collecting the oxidized form, the amalgamated form and/or the particulate bound form of mercury prior to the entry of the emissions stream into the atmosphere.

### DETAILED DESCRIPTION OF FIGURES

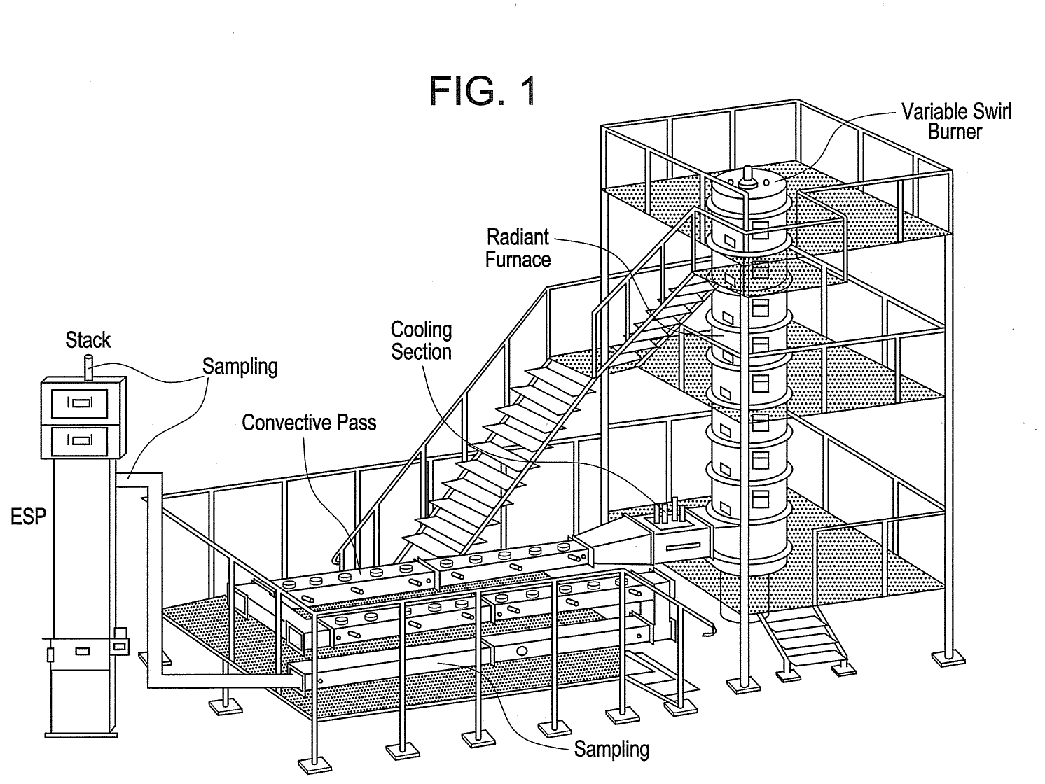

FIG. 1 represents an isometric view of an exemplary thermoelectric power generation facility 100 that can be used for the extraction of mercury from the flue gases;

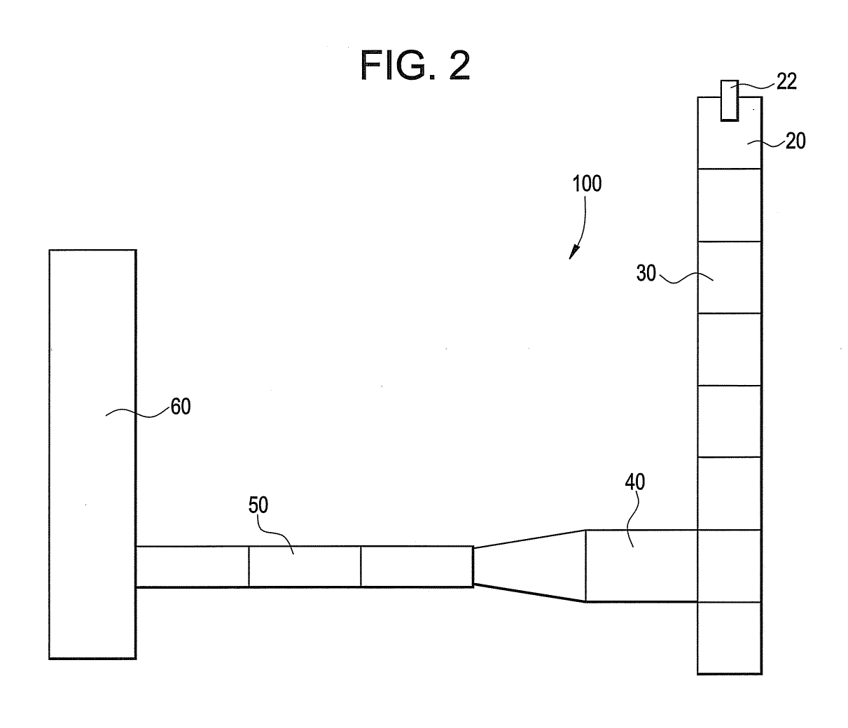

FIG. 2 represents a side view of a similar (not to scale) exemplary thermoelectric power generation facility 100;

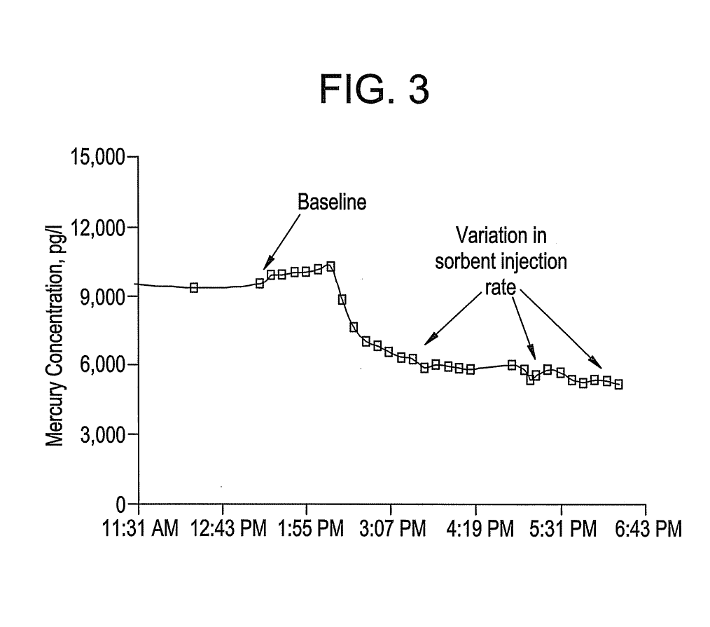

FIG. 3 is a graph that shows data on mercury concentration in flue gas at the electrostatic precipitator (ESP) outlet; and

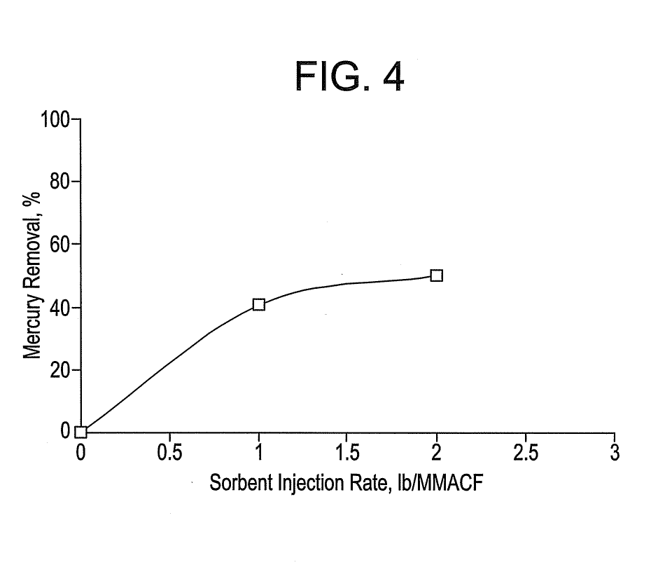

FIG. 4 shows the rate of removal of mercury from the emissions stream after the injection of the catalyst composition.

### DETAILED DESCRIPTION

The use of the terms “a” and “an” and “the” and similar references in the context of describing the invention (especially in the context of the following claims) are to be construed to cover both the singular and the plural, unless otherwise indicated herein or clearly contradicted by context. The modifier “about” used in connection with a quantity is inclusive of the stated value and has the meaning dictated by the context (e.g., it includes the degree of error associated with measurement of the particular quantity). All ranges disclosed herein are inclusive of the endpoints, and the endpoints are independently combinable with each other.

Disclosed herein is a method for extracting elemental mercury from an emissions stream prior to the entry of the emissions stream into the atmosphere. The method can advantageously be used in power plants such as, for example, thermoelectric power plants to reduce emissions of mercury into the atmosphere. In an exemplary embodiment, the method comprises utilizing a halide of a Group Ib element to catalyze the conversion of mercury from its elemental form to a form that can be collected in a particulate control device such as a bag house or an electrostatic precipitator. The form of mercury that can be collected in the particulate control device can be an oxidized form of mercury, an amalgamated form of mercury or mercury that is bound to particles (particulate bound mercury).

In one embodiment, the catalyst composition comprises a halide of a Group Ib element. In another embodiment, the catalyst composition comprises a halide of a Group Ib element mixed with an inert powder. In an exemplary embodiment, the inert powder is fly ash. The catalyst composition is injected into the emissions stream and interacts with the mercury facilitating its conversion to the form that can be collected in a particulate control device.

FIG. 1 represents a pictorial isometric view of an exemplary thermoelectric power generation facility 100 that can be used for the extraction of mercury from the flue gases. FIG. 2 represents a side view of a similar (not to scale) exemplary thermoelectric power generation facility 100 and will be used for purposes of this discussion. It is to be noted that FIG. 2 is not another view of FIG. 1 and FIG. 2 is being used herein for purposes of discussion and exemplifying the invention. As can be seen from the FIGS. 1 and 2, the thermoelectric power generation facility 100 comprises a burner 20, a vertically down-fired radiant furnace 30, a cooling section 40, a horizontal convective pass 50 extending from furnace and a baghouse 60 in communication with the horizontal convective pass 50. The burner 20 is a variable swirl diffusion burner with an axial fuel injector 22. Primary air is injected axially, while the secondary air stream is injected radially through the swirl vanes (not shown) to provide controlled fuel/air mixing. The swirl number can be controlled by adjusting the angle of the swirl vanes. Numerous access ports located along the axis of the facility allow access for supplementary equipment such as reburn injectors, additive injectors, overfire air injectors, and sampling probes. The power generation facility is generally a coal fired facility, although other sources of fuel may also be used. Other sources of fuel, such as, for example, gasoline, diesel, or the like, may also be used in conjunction with coal or independently of coal if desired.

An emissions stream (also termed the “flue gases”) generated by the combustion of fuel in the burner 20 travels downwards towards the cooling section 40, the horizontal convective pass 50 and into the baghouse 60. Particulate matter contained in the emissions stream such as, for example, fly ash that is generated by the combustion of coal is generally collected in the baghouse 60. Mercury in its oxidized form, amalgamated form or particulate bound form is also generally collected in the baghouse 60. Mercury in its elemental form is generally not captured in the baghouse 60.

In an exemplary embodiment, the catalyst composition can be injected into the emissions stream at any point downstream of the burner 20 to facilitate the conversion of the elemental mercury to oxidized mercury, which enhances its capture in the baghouse 60. In one exemplary embodiment, the catalyst composition can be injected into the thermoelectric power generation facility 100 between the burner 20 and the vertically down-fired radiant furnace 30. In another exemplary embodiment, the catalyst composition can be injected into the thermoelectric power generation facility 100 between the vertically down-fired radiant furnace 30 and the cooling section 40. In yet another exemplary embodiment, the catalyst composition can be injected into the thermoelectric power generation facility 100 between the cooling section 40 and the horizontal convective pass 50. In yet another exemplary embodiment, the catalyst composition can be injected into the thermoelectric power generation facility 100 between the horizontal convective pass 50 and the baghouse 60.

As noted above, the catalyst composition comprises a Group Ib element. It is generally desirable for the catalyst composition to be easily dispersed in the emissions stream during their transport downstream from the burner. In other words, it is desirable for the residence time of the catalyst composition in the emissions stream to be maximized in order to effect the maximum conversion of the elemental form of mercury into the oxidized form. In one exemplary embodiment, it is desirable for the initial catalyst composition to be injected into the emissions stream at a point immediately downstream of the burner 20 and to be present in the emissions stream at the baghouse 60. In this embodiment, the catalyst composition remains in the emissions stream and continuously converts the elemental form of mercury to the oxidized form, the amalgamated form or the particulate bound form.

It is to be noted that the catalyst compositions may be introduced into the emissions stream at any point from immediately downstream of the burner to a point immediately upstream of the baghouse. In another exemplary embodiment, a plurality of catalyst compositions may be injected into the emissions stream at different locations downstream of the burner 20. The respective catalyst compositions remain in the emissions stream (after their introduction) until they reach the baghouse 60. For example, a first portion of the catalyst composition is injected into the emissions stream at a point located at a distance ‘x’ immediately downstream of the burner 20, while a second portion of the catalyst composition is injected into the emissions stream at a point located at a distance ‘x+x′’ downstream of the burner 20, while a third portion of the catalyst composition is injected into the emissions stream at a point located at a distance ‘x+x′+x″’ downstream of the burner 20, wherein x+x′+x″ is greater than or equal to about x+x′, and wherein x+x′ is greater than or equal to about x. In this example, the first portion of the catalyst composition may comprise a first composition and a first amount, while the second portion of the catalyst composition may comprise the same composition and amount as the first portion or a different composition and a different amount as compared with the first portion. In other words, either the amounts and the compositions of the respective portions may be the same or different when compared with the amounts and the compositions of the other portions added to the emissions stream.

In yet another exemplary embodiment, a plurality of catalyst compositions may be injected into emissions stream, wherein each catalyst composition remains in the emissions stream for only a selected portion of time. In this example, a first portion of the catalyst composition is injected into the emissions stream at a point located immediately downstream of the burner 20. The first portion of the catalyst composition remains dispersed in the emissions stream for a first period of time ‘t’ before substantially dropping out of (precipitating from) the emissions stream. The first portion of the catalyst composition generally facilitates a substantial conversion of the elemental form of mercury to the oxidized form of mercury while it is present in the emissions stream. A second portion of the catalyst composition is also simultaneously or sequentially injected into the emissions stream at a point located at a distance ‘x+x′’ downstream of the burner 20. The second portion of the catalyst composition remains dispersed in the emissions stream for a second period of time ‘t′’ before substantially dropping out of the emissions stream, where t can be greater than or equal to about t′ or less than t′. Here too, either the amounts and the compositions of the respective portions may be the same or different when compared with the amounts and the compositions of the other portions added to the emissions stream. The first portion and the second portion of the catalyst composition generally facilitate a substantial conversion of the elemental form of mercury to the oxidized form, the amalgamated form and/or the particulate bound form of mercury while they are present in the emissions stream.

As noted above, the catalyst composition can comprise an inert powder in addition to the halide of a Group Ib element. Examples of suitable Group Ib elements are copper, silver, gold, or the like, or a combination comprising at least one of the foregoing elements. Examples of suitable halides are fluorides, chlorides, bromides, iodides, or the like, or a combination comprising at least one of the foregoing halides.

The halide of the Group Ib element is generally present in the catalyst composition in an amount of about 2 to about 100 weight percent (wt %), specifically about 15 to about 90 wt %, more specifically about 20 to about 85 wt %, and even more specifically about 30 to about 80 wt %, based upon the total weight of the catalyst composition. Exemplary catalysts are copper iodide (CuI), copper bromide (CuBr), or the like, or a combination comprising at least one of the foregoing catalysts.

The halide of the Group Ib element generally has a particle size of about 0.1 to about 50 micrometers, specifically about 2 to about 25 micrometers, more specifically about 3 to about 20 micrometers.

It is generally desirable for the inert powder that is mixed with the catalyst to have a density that permits the catalyst composition to be dispersed in and transported along with the emissions stream along its path of travel from the burner 20 to the baghouse 60. The inert powder generally has a density of about 1.5 to about 3.5 grams per cubic centimeter (g/cm³), specifically about 2.0 to about 3.0 g/cm³, and more specifically about 2.3 to about 2.7 g/cm³.

It is generally desirable for the inert powder that is mixed with the catalyst to have an alkalinity of about 4 to about 9. An exemplary alkalinity of the inert powder is about 5 to about 7.

Examples of suitable inert powders are fly ash, fumed silica, fumed alumina, clay, montmorillonite, mud (e.g., shale, or the like), zeolite, catalyst modified clay, ceramic materials, refractory materials (e.g., magnesium oxide, calcium oxide, silicon carbide, zirconia), coal ash, powdered coal, or the like, or a combination comprising at least one of the foregoing inert powders. An exemplary inert powder is fly ash. An exemplary fly ash has a density of 2.5 g/cm³.

Fly ash (also known as a coal combustion product, or CCP) is a finely divided mineral residue resulting from the combustion of powdered coal in thermoelectric power generation facility. Fly ash comprises inorganic, incombustible matter present in the coal that has been fused during combustion into a glassy, amorphous structure. Fly ash generally comprises silicon dioxide (SiO₂), aluminum oxide (Al₂O₃) and iron oxide (Fe₂O₃).

Inert powder particles are generally spherical in shape have average particle sizes of about 0.5 micrometers (μm) to about 100 μm, specifically about 2 to about 30 μm, more specifically about 5 to about 15 μm. An exemplary particle size for the fly ash particles is about 10 μm.

In one embodiment, it may be desirable to introduce the catalyst composition into the emissions stream, where the temperature of the stream facilitates maximum efficiency of conversion of the elemental form of mercury to the oxidized form of mercury. In one embodiment, the catalyst composition can be injected into the emissions stream at a temperature of about 160 to about 2,750° F., specifically about 180 to about 2,000° F., and more specifically about 200 to about 1,100° F.

The catalyst composition comprising the inert powder is generally injected into the emissions stream in an amount of 0.1 and 10 pounds per MMACF (pounds of catalyst composition per million cubic feet of flue gas), specifically about 0.2 to about 8 pounds per MMACF, and more specifically about 1 to about 4 pounds per MMACF.

When the catalyst composition comprises fly ash it is desirable for the ratio of the weight of the halide of a Group Ib element to the weight of the fly ash to be about 2:98 to about 20:80, specifically about 5:95 to about 15:85, more specifically about 7:93 to about 17:83. An exemplary the ratio of the weight of the halide of a Group Ib element to the weight of the fly ash is about 10:90.

In one manner of manufacturing the catalyst composition, the catalyst is mixed with the inert powder in a blending device. In one embodiment, the mixing generally involves dry blending of the catalyst with the inert powder. Mixing of the catalyst composition involves the use of shear force, extensional force, compressive force, ultrasonic energy, electromagnetic energy, thermal energy or combinations comprising at least one of the foregoing forces or forms of energy and is conducted in processing equipment wherein the aforementioned forces are exerted by a single screw, multiple screws, intermeshing co-rotating or counter rotating screws, non-intermeshing co-rotating or counter rotating screws, reciprocating screws, screws with pins, barrels with pins, rolls, rams, helical rotors, or combinations comprising at least one of the foregoing. Examples of suitable blending devices are single or multiple screw extruders, Buss kneader, Henschel, helicones, Ross mixer, Banbury, roll mills, or the like.

In one manner of reducing the amount of elemental mercury in an emissions stream, a catalyst composition comprising copper iodide disposed upon fly ash is injected into the emissions stream. In one embodiment, the copper iodide can interact with the elemental mercury in the emissions stream according reaction (I) below.

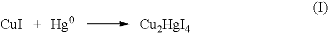

In this reaction, the copper iodide reacts with the elemental mercury to form copper mercury iodide complex, which can then be separated from the emissions stream in the baghouse 60.

In another embodiment, the copper iodide catalyst can decompose in the flue gas to produce a cupric ion and metallic copper as indicated in reaction (II) below.

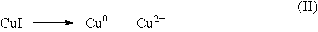

The metallic copper then reacts with elemental mercury to form a copper mercury amalgam as indicated in reaction (III) below.

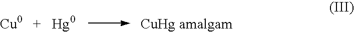

The copper mercury amalgam shown in the reaction (III) is separated from the emissions stream in the baghouse 60.

In yet another embodiment, the copper iodide catalyst decomposes in the emissions stream to produce metallic copper and iodine as indicated in the reaction (IV) below:

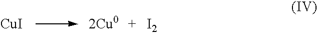

The iodine released in reaction (IV) reacts with elemental mercury to produce mercury iodide as shown in the reaction (V) below:

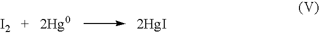

Thus, by removing the elemental mercury from the emissions stream, the emissions that are admitted into the atmosphere have substantially lower amounts of mercury than if they were not treated with the catalyst composition. The catalyst composition can advantageously facilitate the extraction of about 1 to about 80% of the elemental mercury present in the flue gas of a coal-powered plant. Within this range, the catalyst composition can extract up to about 30%, specifically up to about 40%, more specifically up to about 50%, and even more specifically up to about 70% of the elemental mercury present in the flue gas of a coal-powered plant.

The following examples, which are meant to be exemplary, not limiting, illustrate compositions and methods of manufacturing of some of the various embodiments of the catalyst compositions described herein.

### EXAMPLES

This example was conducted to demonstrate the capability of the catalyst in the catalyst composition at reducing the amount of mercury present in the emissions stream of a thermoelectric power generation plant. The catalyst composition comprised copper iodide and fly ash. The copper iodide was obtained from Aldrich Chemical. The copper iodide and the fly ash were mixed in a weight ratio of copper iodide:fly ash::10:90.

Tests were performed in a 1.0 MMBTU/hr (million British thermal unit per hour) Boiler Simulator Facility (hereinafter BSF) to determine effect of the catalyst on mercury removal. The BSF is depicted in FIG. 1 above and is designed to provide a substantially accurate sub-scale simulation of the flue gas temperatures and compositions found in a full-scale boiler. As can be seen in the FIG. 1, the BSF includes a burner, a vertically down-fired radiant furnace, a horizontal convective pass extending from furnace, and a baghouse in communication with the horizontal convective pass.

The burner is a variable swirl diffusion burner with an axial fuel injector, and is used to simulate the approximate temperature and gas composition of a commercial burner in a full-scale boiler. Primary air is injected axially, while the secondary air stream is injected radially through the swirl vanes (not shown) to provide controlled fuel/air mixing. The swirl number can be controlled by adjusting the angle of the swirl vanes. Numerous access ports located along the axis of the facility allow access for supplementary equipment such as reburn injectors, additive injectors, overfire air injectors, and sampling probes.

The radiant furnace is constructed of eight modular refractory lined sections with an inside diameter of 22 inches (55.88 centimeters) and a total height of 20 feet (6.33 meters). The convective pass is also refractory lined, and contains air cooled tube bundles to simulate the superheater and reheater sections of a utility boiler. Heat extraction in radiant furnace and convective pass can be controlled such that the residence time-temperature profile matches that of a typical full-scale boiler. A suction pyrometer (not shown) is used to measure furnace gas temperatures.

The particulate control (collection) device for the BSF is a three-field electrostatic precipitator (hereinafter ESP). Mercury concentration was measured at ESP outlet using a continuous emissions monitoring system capable of measuring both elemental mercury (Hg0) and total mercury (total Hg). Total Hg comprises the sum of elemental mercury, oxidized mercury, amalgamated mercury and particulate bound mercury. The concentration of oxidized mercury can be determined as a difference between total Hg and Hg0 concentrations.

FIG. 3 is a graph that shows data on mercury concentration in flue gas at the ESP outlet. Average flow rate of emissions stream (flue gas) was 150 standard cubic feet per minute (SCFM).

At the beginning of the test, coal combustion occurred at 3% excess O2 without injection of the catalyst composition. This represents baseline operating conditions. The catalyst composition was injected upstream of ESP at a progressively increasing rate. The catalyst composition injection rate in pounds per minute was normalized by volume of flue gas in MMAC/min (millions of cubic feet of flue gas per minute) at the location of the catalyst composition injection. As a result, the catalyst composition injection rate was expressed in lb/MMACF (pounds of catalyst composition per million cubic feet of flue gas). From the FIG. 3, it may be seen that upon the injection of the catalyst into the emissions stream there is a reduction in the mercury content present in the stream.

FIG. 4 shows the rate of removal of mercury from the emissions stream after the catalyst composition injection. From the FIG. 4, it may be seen that about 50% of the mercury can be removed from the emissions stream with the injection of 2.0 lb/MMACF of the catalyst composition.

Thus from the above example, it can be seen that when a catalyst composition comprising a halide of a Group Ib element and fly ash is injected into the an emissions stream comprising flue gas, mercury content in the flue gas can be reduced and amount of greater than or equal to about 50 wt %, specifically greater than or equal to about 60 wt %, and more specifically greater than or equal to about 70 wt % of the total weight of mercury present.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention.

What is claimed is:

1. A catalyst composition comprising:
a halide of a Group Ib element; and
an inert powder.

2. The catalyst composition of claim 1, wherein the catalyst composition comprises a mixture of the inert powder and the halide of the Group Ib element.

3. The catalyst composition of claim 1, wherein the inert powder is fly ash.

4. The catalyst composition of claim 1, wherein the inert powder is fly ash, fumed silica, fumed alumina, clay, montmorillonite, mud, zeolite, catalyst modified clay, ceramic materials, refractory materials, magnesium oxide, calcium oxide, silicon carbide, zirconia, coal ash, powdered coal, or a combination comprising at least one of the foregoing inert powders.

5. The catalyst composition of claim 1, wherein the halide is a bromide, a chloride, an iodide, a fluoride or a combination comprising at least one of the foregoing halides.

6. The catalyst composition of claim 1, wherein the Group Ib element is copper, silver, gold, or a combination comprising at least one of the foregoing Group Ib elements.

7. The catalyst composition of claim 1, wherein the halide of the Group Ib element has an average particle size of about 0.1 to about 50 micrometers.

8. The catalyst composition of claim 1, wherein the inert powder has an average particle size of about 0.1 to about 100 micrometers.

9. The catalyst composition of claim 1, wherein the halide of the Group Ib element is present in an amount of about 2 wt % to about 100 wt %, based on the total weight of the catalyst composition.

10. The catalyst composition of claim 1, wherein the inert powder is present in an amount of up to 98 wt %, based on the total weight of the catalyst composition.

11. The catalyst composition of claim 1, wherein the weight ratio of a halide of a Group Ib element to the inert powder is about 2:98 to about 20:80.

12. The catalyst composition of claim 3, wherein the weight ratio of the halide of a Group Ib element to the fly ash is about 10:90.

13. The catalyst composition of claim 1, wherein the inert powder has a density of about 1.5 to about 3.5 g/cm³.

14. The catalyst composition of claim 1, wherein the inert powder has an alkalinity of about 4 to about 9.

15. An article that employs the composition of claim 1.

16. A composition comprising:
a reaction product of an inert powder, a halide of a Group Ib element and mercury.

17. The composition of claim 16, wherein the inert powder is fly ash.

18. The composition of claim 16, wherein the inert powder is fly ash, fumed silica, fumed alumina, clay, montmorillonite, mud, zeolite, catalyst modified clay, ceramic materials, refractory materials, magnesium oxide, calcium oxide, silicon carbide, zirconia, coal ash, powdered coal, or a combination comprising at least one of the foregoing inert powders.

19. The composition of claim 16, wherein the reaction product comprises the halide of the Group Ib element and mercury.

20. The composition of claim 16, comprising an inert powder and Cu₂HgI₄, an inert powder and a CuHg amalgam, an inert powder and mercury iodide, or a combination comprising an inert powder and at least one of Cu₂HgI₄, the CuHg amalgam or the mercury iodide.

21. The composition of claim 16, wherein the reaction product comprises mercury in its oxidized form, its amalgamated form, its particulate bound form or a combination comprising at least one of the foregoing forms.

22. A method comprising:
injecting a catalyst composition comprising a halide of a Group Ib element and an inert powder into an emissions stream of a thermoelectric power plant;
converting an elemental form of mercury present in the emissions stream into an oxidized form, an amalgamated form and/or a particulate bound form of mercury; and
collecting the oxidized form, the amalgamated form and/or the particulate bound form of mercury prior to the entry of the emissions stream into the atmosphere.

23. The method of claim 22, further comprising injecting a plurality of catalyst compositions either simultaneously or sequentially into the emissions stream.

24. The method of claim 22, wherein the catalyst composition is injected into the emissions stream in an amount of 0.1 and 10 pounds of catalyst composition per million cubic feet of flue gas.

25. The method of claim 22, wherein the catalyst composition is injected into the emissions stream at a temperature of about 750 to about 2750° F.

26. An article that employs the method of claim 22.

27. A method comprising:
injecting a first portion of a first catalyst composition comprising a halide of a Group Ib element and an inert powder into an emissions stream of a thermoelectric power plant;
injecting a second portion of a second catalyst composition comprising a halide of a Group Ib element and an inert powder into the emissions stream of the thermoelectric power plant;
injecting a third portion of a third catalyst composition comprising a halide of a Group Ib element and an inert powder into the emissions stream of the thermoelectric power plant;
converting an elemental form of mercury present in the emissions stream into an oxidized form, an amalgamated form and/or a particulate bound form of mercury; and
collecting the oxidized form, the amalgamated form and/or the particulate bound form of mercury prior to the entry of the emissions stream into the atmosphere.

28. The method of claim 27, wherein the first portion, the second portion and the third portion can be the same or different in weight.

29. The method of claim 27, wherein the first catalyst composition, the second catalyst composition and the third catalyst composition can be the same or different.

30. The method of claim 27, wherein the first catalyst composition is injected into a first location of the thermoelectric power plant, the second catalyst composition is injected into a second location of the thermoelectric power plant and the third catalyst composition is injected into a third location of the thermoelectric power plant.

31. The method of claim 30, wherein the first location of the thermoelectric power plant, the second location of the thermoelectric power plant and the third location of the thermoelectric power plant are the same or different.
